(19) United States
(12) Patent Application Publication
(10) Pub. No.: US 2009/0092459 A1
(43) Pub. Date: Apr. 9, 2009

(54) EXPANSIBLE FIXING PLUG

(76) Inventor: Aaron Daly, Pfalzgrafenweiler (DE)

Correspondence Address: MICHAEL J. STRIKER, 103 EAST NECK ROAD, HUNTINGTON, NY, 11743, US

(21) Appl. No.: 12/299,343

(22) PCT Filed: Jun. 19, 2007
(86) PCT No.: PCT/EP07/05374

§ 371 Date: Nov. 3, 2008

(30) Foreign Application Priority Data
Jun. 27, 2006 (DE) 10 2006 029 414.9

(51) Int. Cl. F16B 13/12

(52) U.S. Cl. 411/80.1

(57) ABSTRACT

The invention relates to an expansible fixing plug (1) having two expansion limbs (4), which are expansible by introduction of a screw (not shown). To increase stability, it is proposed according to the invention to join the expansion limbs (4) in the peripheral region by angular connectors (7) which are integral with the expansion limbs (4). The connectors (7) are angled or curved in two notional planes relative to the expansible fixing plug (1); they can thus easily stretch and do not impede the expansion of the expansion limbs (4) to any appreciable extent.

The invention relates to an expansible fixing plug having the features of the preamble of claim 1.

Expansible fixing plugs are known per se. They have expansion limbs which can be pressed apart from one another by introduction of a pin-like expander element, this being referred to as expansion. Screws, including nail screws, are customary as expander elements, but it is also possible to expand the expansible fixing plug by introducing a nail between the expansion limbs. For example, two expansion limbs can be formed by a slot passing transversely through the expansible fixing plug in a longitudinal centre plane of the expansible fixing plug. More than two expansion limbs, for example three or four, are also possible.

The problem of the invention is to stabilise the expansion limbs of an expansible fixing plug.

That problem is solved according to the invention by the features of claim 1.

The expansion limbs of the expansible fixing plug according to the invention are joined in the peripheral direction by deformable connectors which over their course change direction relative to the expansible fixing plug. “In the peripheral direction” means that the connectors are located in a peripheral region of the expansible fixing plug and do not block the longitudinally central hole of the expansible fixing plug, which hole serves for introduction of the pin-like expander element and is also referred to as a screw channel. The connectors can run, for example, in tangential or chordal planes of the expansible fixing plug. For the change of direction, the connectors can have, for example, an angular, that is to say kinked, configuration or a curved, for example C-shaped or U-shaped, configuration. A change in shape allows the connectors to stretch or shorten, so that a change in the spacing of the expansion limbs is possible. The spacing of the expansion limbs from one another can be increased for expansion of the expansible fixing plug; it can also be reduced for insertion into a drilled hole.

By virtue of the expansion limbs' being joined to one another in accordance with the invention in the peripheral region of the expansible fixing plug, the expansion limbs are stabilised and the resistance to torsion of the expansible fixing plug in the region of the expansion limbs is increased. The resistance to bending of the expansion limbs is also increased. In particular, there is a reduced risk of the expansion limbs' bending sideways in opposite tangential or secantial directions when an expander screw is being screwed in and of the screw's escaping between the expansion limbs. The connectors according to the invention guide the pin-like expander element between the expansion limbs and prevent the pin-like expander element from escaping laterally. Because the connectors change direction over their course, which allows the connectors to stretch as a result of a change in shape, the connectors' resistance to a change in the spacing of the expansion limbs is low. The expansion force required for expanding the expansion limbs is increased only slightly. Accordingly, the force required to introduce the expander element into the expansible fixing plug or the moment required for introduction is also increased only slightly.

In a preferred construction in accordance with the invention, the connectors change direction in two notional planes relative to the expansible fixing plug; they thus have a configuration that is curved or angled in two different directions. The connectors' capacity to stretch is thus increased and their resistance to stretching reduced. In principle, the direction of the connectors can also change in more than two notional planes. The planes in which the connectors change direction are, for example, a tangential or secantial plane and a radial plane of the expansible fixing plug.

In particular, the expansible fixing plug according to the invention is made of plastics material, for example by injection-moulding. The connectors are integral with the expansible fixing plug; the expansible fixing plug can be produced together with the connectors in one operation.

The invention is explained in greater detail below with reference to an exemplary embodiment shown in the drawing:

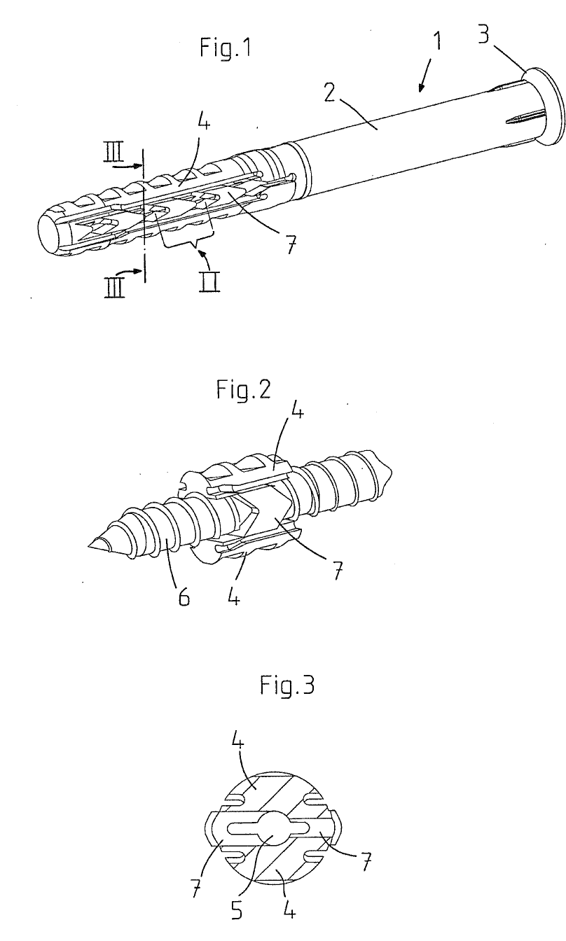

FIG. 1 is a perspective view of an expansible fixing plug according to the invention;

FIG. 2 is a longitudinal portion of the expansible fixing plug in accordance with the portion marked II in FIG. 1; and

FIG. 3 is a cross-section through the expansible fixing plug along line III-III in FIG. 1.

The expansible fixing plug 1 according to the invention shown in FIG. 1 has a tubular shank 2 with a funnel-shaped collar 3 at one end of the expansible fixing plug 1, which end is referred to as the rear end. At the end of the shank 2 remote from the collar 3, the expansible fixing plug 1 is continued by two expansion limbs 4. The expansion limbs 4 extend parallel to one another in the longitudinal direction of the expansible fixing plug 1. The two expansion limbs 4 are separated from one another by a slot which passes transversely through the expansible fixing plug 1 in the region of the expansion limbs 4 in a longitudinal centre plane of the expansible fixing plug 1, the expansion limbs 4 occupying approximately segments of a circle in the cross-section of the expansible fixing plug 1 (FIG. 3). On their faces that face one another, the expansion limbs 4 have longitudinal grooves which form a screw channel 5 (FIG. 3). For expansion and anchoring of the expansible fixing plug 1 in a manner known per se, a screw 6 shown only in FIG. 2 is introduced through the shank 2 into the screw channel 5. The screw 6 presses the two expansion limbs 4 apart, that is to say it expands the expansible fixing plug 1.

The two expansion limbs 4 are joined to one another along their two longitudinal sides by connectors 7 (FIG. 2). The connectors 7 are located in a peripheral region of the expansible fixing plug 1. As can be seen especially in FIG. 2, the connectors 7 have one angling, that is to say they change direction, in a tangential or secantial plane of the expansible fixing plug 1. The angling can also be referred to as a kink or kinking in the connectors 7. As a result of their angling, the connectors 7 can be stretched or shortened by a change in shape, the angling becoming smaller or larger. As a result, the expansion limbs 4 can be moved apart from one another for expansion and moved closer to one another for insertion of the expansible fixing plug 1 into a drilled hole (not shown) almost unimpeded by the connectors 7.

Apart from the angling in the tangential or secantial planes of the expansible fixing plug 1, the connectors 7 also change direction as a result of a U-shaped configuration in radial planes of the expansible fixing plug 1, as can be seen in FIG. 3. The connectors 7 accordingly change direction in two planes with respect to the expansible fixing plug 1, firstly as a result of the angling of the connectors 7 in the secantial or tangential planes of the expansible fixing plug 1, which can be seen in FIG. 2, and secondly as a result of their U-shaped configuration in the radial planes of the expansible fixing plug 1, which can be seen in cross-section in FIG. 3. The ability of the connectors 7 to be stretched or shortened by a change in shape is therefore increased; their resistance to expansion of the expansion limbs 4 is reduced.

The connectors 7 increase the resistance to torsion of the expansible fixing plug 1 in the region of the expansion limbs 4 and the bending resistance of the expansion limbs 4 with respect to bending parallel to their faces that face one another. Furthermore, the connectors 7 guide the screw 6 in the screw channel 5. The connectors 7 prevent the screw 6, as a result of its rotation on being screwed in, from moving the expansion limbs 4 sideways in opposite directions and from escaping between the expansion limbs 4. The connectors 7, by virtue of their easy deformability, nevertheless do not impede the expansion of the expansion limbs 4 to any appreciable extent.

The exemplary embodiment of the expansible fixing plug 1 shown has been produced in one piece, including the connectors 7 that join the expansion limbs 4, by injection-moulding from plastics material. The connectors 7 are, as already mentioned, able to be stretched by a change in shape, that is to say by a reduction in their angling shown in FIG. 2 and by a widening of their U-shape, shown in FIG. 3, towards a V-shape, with the yoke remaining curved.

1. Expansible fixing plug, having expansion limbs (4), between which a pin-like expander element (6) is introducible for expansion of the expansible fixing plug (1), characterized in that the expansion limbs (4) are joined in the peripheral direction by deformable connectors (7) which change direction relative to the expansible fixing plug (1), which connectors can be stretched or shortened by a change in shape and thus allow a change in the spacing of the expansion limbs (4).

2. Expansible fixing plug according to claim 1, characterized in that the connectors (7) have an angular configuration.

3. Expansible fixing plug according to claim 1, characterized in that the connectors (7) change direction in two notional planes relative to the expansible fixing plug (1).

4. Expansible fixing plug according to claim 1, characterized in that the expansible fixing plug (1), including the connectors (7), is made in one piece from plastics material.
